(19) United States
(12) Patent Application Publication
(10) Pub. No.: US 2001/0054129 A1
(43) Pub. Date: Dec. 20, 2001

(54) Method, system and computer program

(76) Inventor: Cornelis Bernardus Aloysius Wouters, Eindhoven (NL)

Correspondence Address: U.S. Philips Corporation, 580 White Plains Road, Tarrytown, NY, 10591, US

(21) Appl. No.: 09/846,596

(22) Filed: Apr. 30, 2001

(30) Foreign Application Priority Data
May 4, 2000 (EP) 00201616.0

(51) Int. Cl. G06F 12/00

(52) U.S. Cl. 711/103; 711/163

(57) ABSTRACT

A method of and system for managing a storage medium (10) comprising a plurality of blocks (21). When a first block (22) is to be erased, a determination is made whether the wear level of the first block (22) is acceptable for executing said erasure. If so, the data on the first block (22) are erased. Otherwise a second block (23) is chosen with a lower wear level than the first block (22), and the data of the second block (23) is copied to the first block (22). Preferably, every block (22) has an associated counter for keeping track of the number of times it has been erased. As blocks that have been rarely erased in the past are less likely to be erased in the future, the first block (22) will subsequently be erased less often and therefore its lifetime is extended. The second block (23) can now be used to store new data and will be used more often.

The invention relates to a method of data management on a storage medium, the storage medium comprising a variety of blocks in which data can be stored, a first block from said variety of blocks being selected to execute a mutation on.

The invention also relates to a system for data management on a storage medium, the storage medium comprising a variety of blocks in which data can be stored, the system being arranged for selecting a first block from said variety of blocks to execute a mutation on.

A method of the type defined in the opening paragraph is known from U.S. Pat. No. 5,896,393. Non-volatile storage media such as EEPROMs and flash memories are advantageous in that the data stored thereon are saved when the current is switched off. However, in addition to having a relatively long access time, they have the drawback that each writing operation requires a preceding delete operation and that each write and delete operation degrades the storage medium. Such a storage medium is often subdivided into blocks which can be written, read out and deleted individually. A problem with this is that only a restricted number of mutations, such as erase and write operations of a block are possible before the block is worn out.

U.S. Pat. No. 5,896,393 describes a method of management of a storage medium, which storage medium comprises a variety of blocks. The method initially selects a first block as a storage block (storage array) and a second block as an update block (update array) in the storage medium. Files are stored on the first block and are then marked as “active”. Stored files may be erased. This happens by marking them as “inactive”, without executing an erase operation on one of the blocks. Periodically, the stored blocks which are marked as “active”, are copied to the second block, after which the first block is erased. Subsequently, the second block is denoted as a storage block and another block is selected as an update block. The selection in favor of the other block is made by selecting an arbitrary block from the variety of blocks, or by selecting the block logically preceding the stored block. Periodically copying all the stored files to the second block is detrimental in that also files are copied that had not needed copying. Arbitrarily selecting is detrimental in that there is no guarantee that all the blocks are ever selected as a stored block, so that a number of blocks will wear out more than others. In addition, this method is detrimental in that it takes no account of the fact that some files need to be adapted much and others little. All the files are copied equally often, even if this is not necessary. As a result, the storage medium is not worn out uniformly and parts of the storage medium will break down far ahead of other parts.

It is an object of the invention to provide a method of data management on a storage medium, which extends the lifetime of the storage medium during which maximum capacity is available.

This object is achieved with the method according to the invention by determining whether the wear level of the first block is acceptable for executing the mutation, and if so, executing the mutation on the first block, and otherwise

choosing from said variety a second block with a lower wear level than the first block, and

copying the data of the second block to the first block.

The invention is based on the recognition that when the data in a block changed little in the past, they will not change much in the future either. A storage medium generally contains a mixture of program code and data which are used by the program code. The program code will rarely change, whereas the data are adapted regularly. The blocks comprising program code then have a lower wear level than the blocks comprising data. Starting from the recognition of the invention, the number of mutations on the first block may be restricted in the future by copying the data of a second block, which block has a lower wear level, to the first block. As a result, the lifetime of the first block is extended. Also, the first block will not be selected to undergo a mutation if there are other blocks whose wear levels are lower than the wear level of the first block. Thus, there will be no wear on the first block until the other blocks have worn equally much. This evenly distributes the wear over the entire storage medium and lengthens the lifetime of the storage medium.

In a particular embodiment, the blocks from said variety of blocks have an associated counter for counting the number of mutations in the block concerned, and that, when the value of the counter of the first block is smaller than a limit value, the value of the counter is increased and the mutation is executed, and otherwise a block of which the counter has a lower value than the counter of the first block is chosen as the second block. The counter is used for counting the number of mutations on the respective block. With each mutation the value of this counter is increased. When the counter exceeds the limit value, this is a sign that the respective block has undergone many mutations. The block has then undergone much wear and there is then a great chance of the block breaking down, so the data from the second block, whose associated counter has a lower value than the counter of the first block, is then copied to the first block. Using a counter is a very simple and efficient way of keeping track of the wear level.

In a particular embodiment of the method, the lower value is the lowest value of the counts of the blocks from said variety. This embodiment is advantageous in that all the blocks are eventually chosen as a second block, so that, eventually, all the blocks are used equally much. If the lower value is not the lowest value, then there is the possibility of a block not being selected or selected less often, so that this block is used less often and therefore experiences less wear than the other blocks. With this embodiment it is achieved that all the blocks are used equally much, so that the lifetime of the storage medium is maximized.

In a particular embodiment of the method, the limit value is increased when the majority of the counters of the blocks from said variety exceed the limit value. This embodiment is advantageous in that the limit value can now be initially set to a low value, so that the wear of the storage medium is evenly distributed without large differences in the values of the associated counters of various blocks. With a large limit value, differences of values of the counters may run high, so that a number of blocks reach the end of their lifetime faster, whereas other blocks have experienced a few mutations and may still last for a long time.

In a particular embodiment of the method, the second block is erased after the data have been copied from the second block to the first block. This embodiment is advantageous in that the second block is now immediately available for storage of new data.

In a particular embodiment of the method, the mutation comprises erasing the first block. This embodiment is advantageous in that the number of erase operations is a reasonably accurate yardstick of the amount of wear, since a block especially wears when it is erased.

It is also an object of the invention to provide a system for data management on a storage medium, with which the lifetime of the storage medium during which maximum capacity is available is extended.

This object is achieved according to the invention by a system which is characterized by control means for determining whether the wear level of the first block is acceptable for executing the mutation, and if so, executing the mutation on the first block, and for otherwise

choosing from said variety a second block with a lower wear level than the first block, and

copying the data of the second block to the first block.

In a particular embodiment of the system, the blocks from said variety of blocks have an associated counter for counting the number of mutations in the block concerned, and the control means are arranged for, when the value of the counter of the first block is smaller than the limit value, increasing the value of the counter and executing the mutation, and for otherwise choosing a block of which the counter has a lower value than the counter of the first block as the second block.

In a particular embodiment of the system, the system is arranged for initially constructing a table in which the value of the counters of the blocks are stated. This may be effected, for example, by starting the system. This embodiment is advantageous in that the table may then be stored in fast, volatile memory, so that consulting the table is accelerated compared to the reading of the counter from the associated block.

In a particular embodiment of the system, the control means are arranged for erasing the second block after the data from the second block have been copied to the first block. This embodiment is advantageous in that if the functioning of the system is interrupted during the copying process, for example, due to a power failure, the data is still present on the second block.

The invention further relates to a computer program product enabling a programmable device to function as a system according to the invention.

These and other aspects will be explained in more detail with reference to the drawing in which:

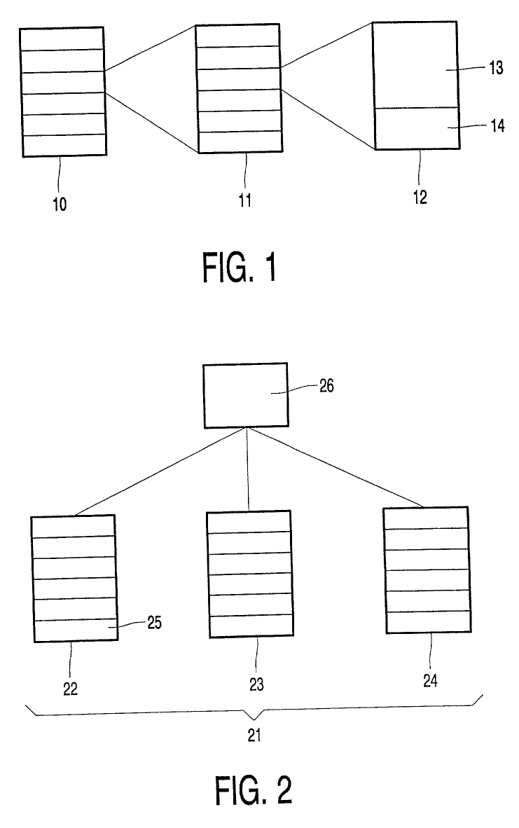

FIG. 1 is a diagrammatic representation of a storage medium; and

FIG. 2 is a diagrammatic representation of a system for data management according to the invention.

Throughout the figures, same reference numerals indicate similar or corresponding features. Some of the features indicated in the drawings are typically implemented in software, and as such represent software entities, such as software modules or objects.

FIG. 1 shows the structure of a storage medium 10 as this is used in the system according to the invention. The storage medium 10 comprises a variety of blocks. A block 11 in its turn comprises a variety of pages. A page 12 may consist of a first part 13 and a second part 14, the first part 13 being used for storing data and the second part 14 for storing associated information such as error correcting codes for the data that are stored on the first part 13. An example of such a storage medium 10 is the Samsung KM29U128T NAND flash device. This storage medium is subdivided into 1024 blocks of 16 kilobytes each. Each block is subdivided into 32 pages of 528 bytes. A page is again subdivided into a first part of 512 bytes and a second part of 16 bytes.

With storage media such as NAND flash memories, the individual bytes cannot be accessed directly. The reading and writing of data is effected per page 12. Furthermore, it is not possible to erase individual pages. Erasure takes place by erasing a complete block 11 with pages at once. It is possible to a limited extent (typically 5 to 10 times) to rewrite a page without erasing the block containing the page.

Erasing a complete block when the data on a page are no longer valid is usually undesired. A known manner of solving this problem is defining different possible statuses for a page. The status of a page 12 can be stored in the second part 14, for example, in the form of one or more bit flags.

A page 12 may then be erased by changing the status thereof into “erased”. When a block is erased, also the status of all the pages in the block is changed to “free”. A page that is written to changes to the “written” status. Only pages that have the “free” status can be written to. Thus, a page having status “erased” cannot be used any longer until the block in which it is situated is erased.

This technique results in no space being vacated on the storage medium by erasing a page. The more the storage medium is used, the less free space is available. The only way to reclaim this free space is by erasing a block. Erasing blocks to reclaim free space may be effected, for example, periodically, or at the time when the amount of free space has dropped to below a certain limit.

Erasing blocks without pages having the “written” status is to be preferred, because no data are lost then during the erasure. However, if there are no such blocks, or more free space is needed than can be reclaimed by erasing only these blocks, blocks will also have to be erased that do contain pages having the “written” status. This means that first another block is to be found to which all the pages having the “written” status are to be copied to, in order for the data on these pages to be saved.

It may be necessary to adapt administrative data after the copying operation. If, for example, files are stored on the storage medium 10, there may be a file allocation table belonging to the storage medium 10 in which the correspondence is stated between a file and one or more pages containing the contents of the file. This table is then to be adapted, so that the right pages belonging to the file are stated. Alternatively, it is possible that there is an interface with which logic addresses for stored data are translated to the respective pages on which these data are stored. In that case the information the interface makes use of is to be adapted. For other systems a comparable measure is to be carried out.

Since reclaiming free space in this manner takes time, it is to be recommended to restrict the number of blocks to be erased, for example, to the number of blocks that is necessary for storing new data in, or up to a certain upper limit.

The storage medium can endure only a limited number of erase operations per block. When a block is erased too many times, the amount of wear is so great that it breaks down and is then no longer usable for storing new data in. For a typical NAND flash memory, 100,000 operations are possible without making use of error correcting codes, and 1,000,000 operations when error correcting codes are made use of.

FIG. 2 shows a system for managing data on a storage medium 10. The storage medium 10 is, for example, a NAND flash memory. It has the characteristic features as described in FIG. 1 and thus comprises a variety of blocks 21, with each block 22 from the variety 21 containing a number of pages 25 in which data can be stored.

The system further includes a control unit 26. This unit can read and write data on pages and can erase blocks. The control unit 26 is also to register what data are stored where and to carry out other administrative tasks that are necessary for the management of the storage medium 10. Although the control unit 26 is realized here as a separate part of the system, it is alternatively possible to implement the functions of the control unit 26 in software in a device driver for controlling the storage medium 10, or to have them form part of the operating system of a computer system in which the storage medium 10 is included.

One of the tasks of the control unit 26 is erasing blocks for reclaiming the free space. It may be necessary for the control unit 26 to do this when data are to be written and there is insufficient space available for this. The control unit 26 may also periodically erase blocks or, for example, keep track of the amount of free space in a counter and erase blocks when this amount drops below a defined limit.

Since the mutation of a block brings along wear, it is useful to keep track of the number of times a block has undergone a mutation. In the preferred embodiment, the blocks from said variety 21 therefore have an associated counter for keeping track of the number of times a mutation of a block has been carried out. In a preferred embodiment this counter counts the number of erase operations of the block. The counter can be stored in a storage space in the block 11, for example, in the second part 14 of one or more pages 12 of the block 11. Alternatively to using a counter, the blocks may have some other associated identifier for signaling that the wear level is becoming unacceptable. The control unit 26 could also use a heuristic like the average number of erase operations on individual blocks as a measure of the wear level.

The counters may also be included, for example, in a table, so that it is possible to read the value of the counters rapidly. Likewise, it is possible to arrange the system so that, initially, for example when the system is started up, a table is constructed by reading the value of the counters of all the blocks from the memory 10 and storing them in the table. The table may then be stored in a fast volatile memory, so that consulting the counter for a block is accelerated compared to the situation in which the counter of the associated block has to be read from the memory 10 directly.

The control unit 26 can now determine how often the selected block 22 has been erased. If the selected block 22 is to be erased again, for example, because room is to be made on the storage medium 10, or because the data on the selected block 22 are to be erased, the control unit 26 in the preferred embodiment inspects the value of the associated counter. When the value of the counter is smaller than a limit value, the control unit 26 erases the block 22 and increments the counter.

When the first block 22 is to be erased to make room on the storage medium 10, the control unit 26 must copy to another block 24 the pages having the “written” status present in this block 22 prior to erasing them, as is explained with reference to FIG. 1.

It may happen that the wear level of the first block 22 is found to be unacceptable. In the preferred embodiment, this happens when the value of the associated counter turns out to be larger than the limit value. To avoid the block 22 being erased many times more, so that the amount of wear on the block 22 is so great that the block breaks down, the control unit 26 then selects a second block 23 from said variety 21, preferably by inspecting the associated counters of all the blocks and selecting a block whose counter has a lower value than the counter of the first block 22.

It is recommended that this lower value is the lowest value of the values of the counters of the blocks from the variety 21. In that case, all the blocks are ever chosen as a second block 23, so that, eventually, all the blocks are used equally often. If the lower value is not the lowest value, there is the possibility that a block is not chosen or chosen less often than other blocks, so that this block is used less often and thus undergoes less wear than the other blocks.

The control unit 26 now copies to another block 24 the pages having the “written” status now present in this block 22, prior to erasing them. After this, the control unit 26 can erase the first block 22 and copy the data from the second block 23 to the first block 22. So doing, pages of the second block 23 having the “erased” status may be skipped.

After the data have been copied from the second block 23 to the first block 22, the control unit 26 can erase the second block 23. The space on the second block 23 is then directly available for storing new data.

When the majority of the counters of all the blocks on the storage medium 10 from said variety exceed the limit value or have reached it, the limit value can be raised. The control unit 26 can easily verify whether this is the case, because for selecting the second block 23 the unit is to inspect the associated counters of all the blocks and can then directly verify whether still sufficient counters are below the limit value. To avoid the limit value being increased too many times, it is to be preferred for the limit value not to be increased until all the counters have reached or exceed the limit value. The increasing of the limit value means that blocks whose counter value had reached the limit value till that moment, are now again eligible for being erased. Ideally, this should only happen when all the blocks have reached the limit value, because then all the blocks have been erased equally many times and the wear is therefore distributed uniformly over the entire storage medium 10.

The limit value is to be selected such that the value of the counter of the first block 22 does not reach the limit value too often. The execution of the operations described above takes extra time and causes some wear in both the first block 22 and the second block 23.

To maximize the lifetime of the storage medium 10, it is necessary for all the blocks to wear equally much. In theory this may be reached by setting the limit value to 1, so that a block is no longer erased after the first erasure, until all the other blocks have also been erased once. After this, the limit value is to be raised by 1. However, this cannot be feasible in practice.

An initial limit value suitable in practice is 1% of the lifetime of the storage medium. When the majority of the counters have reached this value, the limit value can be increased by another 1% of the lifetime.

1. A method of data management on a storage medium (10), the storage medium (10) comprising a variety of blocks (21) in which data can be stored, a first block (22) from said variety of blocks (21) being selected to execute a mutation on, characterized by determining whether the wear level of the first block (22) is acceptable for executing the mutation, and if so, executing the mutation on the first block (22), and otherwise
choosing from said variety a second block (23) with a lower wear level than the first block (22), and
copying the data of the second block (23) to the first block (22).

2. A method as claimed in claim 1, characterized in that the blocks from said variety of blocks (21) have an associated counter for counting the number of mutations in the block concerned, and that, when the value of the counter of the first block (22) is smaller than a limit value, the value of the counter is increased and the mutation is executed, and otherwise a block of which the counter has a lower value than the counter of the first block (22) is chosen as the second block (23).

3. A method as claimed in claim 2, characterized in that the lower value is the lowest value of the values of the counters of the blocks from said variety.

4. A method as claimed in claim 2, characterized in that the limit value is increased when the majority of the counters of the blocks from said variety exceed the limit value.

5. A method as claimed in claim 1, characterized in that the second block (23) is erased after the data of the second block (23) have been copied to the first block (22).

6. A method as claimed in claim 1, characterized in that the mutation comprises erasing the first block (22).

7. A system for data management on a storage medium (10), the storage medium (10) comprising a variety of blocks in which data can be stored, the system being arranged for selecting a first block (22) from said variety of blocks (21) to execute a mutation on, characterized by control means (26) for determining whether the wear level of the first block (22) is acceptable for executing the mutation, and if so, executing the mutation on the first block (22), and for otherwise
choosing from said variety a second block (23) with a lower wear level than the first block (22), and
copying the data of the second block (23) to the first block (22).

8. A system as claimed in claim 7, characterized in that the blocks from said variety of blocks (21) have an associated counter for counting the number of mutations in the block concerned, and in that the control means (26) are arranged for, when the value of the counter of the first block (22) is smaller than the limit value, increasing the value of the counter and executing the mutation, and for otherwise choosing a block of which the counter has a lower value than the counter of the first block (22) as the second block (23).

9. A system as claimed in claim 8, characterized in that the lower value is the lowest value of the values of the counters of the blocks from said variety.

10. A system as claimed in claim 8, characterized in that the control means (26) are arranged for increasing the limit value when the majority of the counters of the blocks from said variety exceed the limit value.

11. A system as claimed in claim 8, characterized in that the system is arranged for initially constructing a table in which the value of the counters of the blocks are stated.

12. A system as claimed in claim 7, characterized in that the control means (26) are arranged for erasing the second block (23) after the data from the second block (23) have been copied to the first block (22).

13. A computer program product enabling a programmable device to function as a system as claimed in claim 7.
